(19) United States
(12) Patent Application Publication
(10) Pub. No.: US 2016/0275944 A1
(43) Pub. Date: Sep. 22, 2016

(54) SPEECH RECOGNITION DEVICE AND METHOD FOR RECOGNIZING SPEECH

(71) Applicant: RayTron, Inc., Osaka (JP)

(72) Inventors: Mitsuji YOSHIDA, Osaka (JP); Yasuhito ARAKANE, Osaka (JP)

(21) Appl. No.: 15/071,878

(22) Filed: Mar. 16, 2016

(30) Foreign Application Priority Data
Mar. 19, 2015 (JP) 2015-055976

(51) Int. Cl. G10L 15/10; G10L 15/12; G10L 15/14; G10L 15/04

(52) U.S. Cl. CPC G10L 15/10; G10L 15/04; G10L 15/12; G10L 15/142

(57) ABSTRACT

A speech recognition device includes a speech input section that inputs speech of a continuously uttered phrase set, a first identifying section that identifies a prestored word included in the phrase set, and a second identifying section that identifies an additionally stored word included in the phrase set based on pattern data of feature value sequences of the additionally stored words and feature values of the input speech. The first identifying section includes a cut-out section and a recognition processing section. The cut-out section extracts a prestored word candidate by making comparison between template feature value sequences of the prestored words and a feature value sequence of the speech in a target segment, and cuts out a speech segment where the extracted prestored word is present. The recognition processing section identifies the prestored word based on the feature values in the speech segment cut out by the cut-out section through a recognition process.

### BACKGROUND OF THE INVENTION

(1) Field of the Invention

This invention relates to devices and methods for recognizing speech, and more particularly to a speech recognition device and a speech recognition method for recognizing speech using an isolated word recognition technique.

(2) Description of the Related Art

In general, speech recognition algorithms developed for unspecified speakers are different from speech recognition algorithms dealing with additionally stored words. For speech recognition devices that hold prestored words for unspecified speakers and allow users to add any words to be recognized, techniques have been proposed to recognize the prestored words and the additionally stored words using different algorithms.

For example, Japanese Patent No. 3479691 (PTL 1) discloses that a speaker-dependent recognizer operates based on a Dynamic Time Warping (DTW) method and a speaker-independent recognizer operates based on a Hidden Markov Model (HMM) method. In this disclosure, a postprocessing of results encumbered with a certain recognition probability of both the speech recognizers takes place in a postprocessing unit.

### SUMMARY OF THE INVENTION

A speech recognition device having a capability of recognizing both prestored words and additionally stored words can recognize speech including p restored words and additionally stored words uttered one by one with a pause between the words. However, if the speech includes prestored words and additionally stored words uttered continuously and mixedly, the speech recognition device may have high rates of false recognition of the utterance because there are no explicit breaks between the words. To prevent false recognition, the syntax analysis, as mentioned in PTL 1, or other processes are indispensable to properly recognize continuous speech utterances of the prestored words and additionally stored words.

The present invention has been made to solve the above-mentioned problems and has an object to provide a speech recognition device and a speech recognition method that can recognize continuously uttered speech of the prestored words and additionally stored words without syntax analyses.

A speech recognition device in an aspect of the present invention includes a storage section that stores model parameters of a plurality of prestored words and pattern data of feature value sequences of a plurality of additionally stored words added by a user, a speech input section that inputs speech of a phrase set including a prestored word and an additionally stored word continuously uttered, a first identifying section that identifies the prestored word included in the phrase set based on the model parameters stored in the storage section and feature values of the speech input by the speech input section, and a second identifying section that identifies the additionally stored word included in the phrase set based on the pattern data stored in the storage section and the feature values of the speech input by the speech input section. The first identifying section includes a cut-out section and a recognition processing section. The cut-out section extracts a prestored word candidate by making comparison between template feature value sequences of the prestored words and a feature value sequence of the speech in a target segment, and cuts out a speech segment where the extracted prestored word candidate is present. The recognition processing section identifies the prestored word based on feature values in the speech segment cut out by the cut-out section through a recognition process using the model parameters.

Preferably, the speech recognition device further includes an acceptability determination section that determines whether the word, that is identified by the first identifying section or the second identifying section, is acceptable as a recognition result, an output section that outputs the word accepted by the acceptability determination section, and an updating section that updates the target segment by deleting the speech segment where the word accepted by the acceptability determination section is present from the target segment.

Preferably, the first identifying section firstly performs an identifying process on the speech in the target segment to identify the prestored word, and if the identified result provided by the first identifying section is rejected by the acceptability determination section, the second identifying section performs an identifying process on the speech of the target segment to identify the additionally stored word.

Preferably, the template feature value sequences used by the cut-out section are reconstructed from the model parameters.

In this case, the speech recognition device may further include a reconstruction section that reconstructs the template feature value sequences by determining by calculations feature patterns of the respective prestored words from the model parameters stored in the storage section.

Preferably, the cut-out section performs weighting based on variance information included in the model parameters to extract the p restored word candidate.

Preferably, the second identifying section also includes a cut-out section and a recognition processing section. The cut-out section extracts an additionally stored word candidate by comparing feature value sequences corresponding to the pattern data against a feature value sequence of the speech in the target segment and cuts out a speech segment where the extracted additionally stored word candidate is present. The recognition processing section performs a recognition process for the additionally stored word by comparing a feature value sequence in the cut-out speech segment where the additionally stored word candidate is present against the feature value sequences corresponding to the pattern data.

Alternatively, the second identifying section may identify the additionally stored word by comparing the feature value sequences corresponding to the pattern data against the feature value sequence of the speech in the target segment.

A method for recognizing speech in an aspect of the present invention is executed by a computer equipped with a storage section that stores model parameters of a plurality of prestored words and pattern data of feature value sequences of a plurality of additionally stored words added by a user. The method for recognizing speech includes the steps of inputting speech of a phrase set including a prestored word and an additionally stored word continuously uttered, firstly identifying the prestored word included in the phrase set based on the model parameters stored in the storage section and feature values of the input speech, and secondly identifying the additionally stored word included in the phrase set based on the pattern data stored in the storage section and the feature values of the input speech. The first identifying step includes the steps of extracting a prestored word candidate by making comparison between template feature value sequences of the prestored words and a feature value sequence of the speech in a target segment, and cutting out a speech segment where the extracted prestored word is present, and identifying the prestored word based on feature values in the cut-out speech segment through a recognition process using the model parameters.

According to the present invention, continuously uttered speech of prestored words and additionally stored words can be recognized without syntax analyses.

### BRIEF DESCRIPTION OF THE DRAWINGS

FIG. 1 is a block diagram showing an example hardware configuration of a speech recognition device according to an embodiment of the present invention.

FIG. 2 is a functional block diagram showing a functional configuration of the speech recognition device according to the embodiment of the invention.

FIG. 3 illustrates an example computation of a minimum cumulative distance performed in a recognition process of an additionally stored word in the embodiment of the invention.

FIG. 4 illustrates an example computation of a minimum cumulative distance performed in an extraction process of an additionally stored word candidate or a p restored word candidate in the embodiment of the invention.

FIG. 5 illustrates changes in a template feature value sequence reconstructed from model parameters of a HMM phrase over time in the embodiment of the invention.

FIG. 6 is a graph representing the relationship between a plurality of feature value sequences of a teacher's speech of a HMM phrase and a reconstructed feature value sequence (feature pattern) in the embodiment of the invention.

FIG. 7 is a flowchart showing speech a recognition procedure according to the embodiment of the invention.

FIG. 8 is a flowchart showing a continuous speech recognition procedure according to the embodiment of the invention.

FIG. 9 is a diagram to describe computational expressions used to extract a word candidate in the embodiment of the invention.

FIG. 10 is a graph showing the relationship between a speech waveform used in an experiment and the target segment.

FIG. 11 is a graph showing the relationship between a speech waveform used in an experiment and the target segment.

FIG. 12 is a graph showing the relationship between a speech waveform used in an experiment and the target segment.

FIG. 13 is a graph showing the relationship between a speech waveform used in an experiment and the target segment.

### DETAILED DESCRIPTION OF THE PREFERRED EMBODIMENT

With reference to the drawings, an embodiment of the present invention will be described in detail. The same or similar components are denoted by the same reference symbols or reference numerals throughout the drawings, and the description thereof will not be reiterated.

### <Outline>

A speech recognition device according to this embodiment adopts an isolated word recognition technique, and identifies a word representing a speech signal from a plurality of stored words by analyzing the speech signal and outputs the identified word. The stored words to be recognized include both prestored words for unspecified speakers and additionally stored words for specified speakers. In general, the prestored words are recognized using their own model parameters, while the additionally stored words are recognized using pattern data of their own feature value sequences (feature vector sequences).

The speech recognition device according to this embodiment includes a function of recognizing the p restored words and additionally stored words using different algorithms, and also enables recognition of speech including prestored words and additionally stored words uttered continuously and mixedly (hereinafter, referred to as “continuous speech”).

In this embodiment, the prestored words are recognized in accordance with a HMM method, while the additionally stored words are recognized in accordance with a DTW algorithm. Therefore, in the following description, the term “prestored words” is referred to as “HMM phrase”, and the term “additionally stored words” is referred to as “DTW phrase”.

A detailed description about the configuration and operation of the speech recognition device will be given below.

### <Configuration>

### (Hardware Configuration)

The speech recognition device according to this embodiment can be implemented by a general-purpose computer, for example, a personal computer (PC).

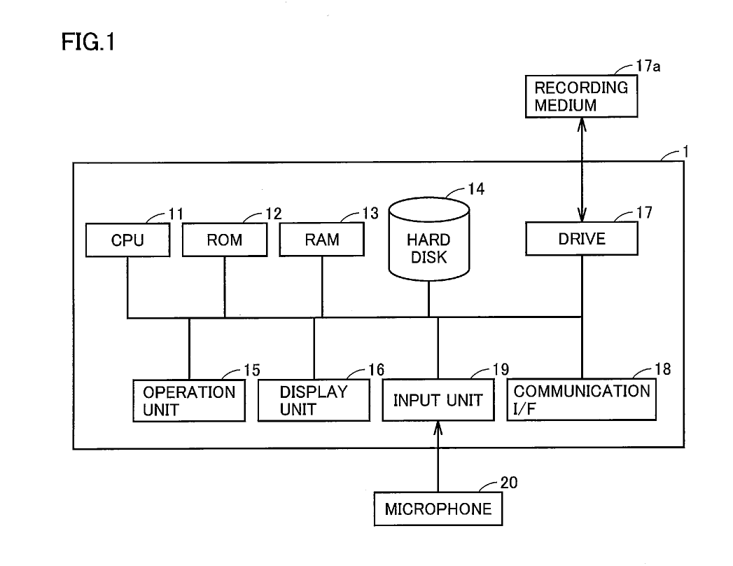

FIG. 1 is a block diagram showing an example hardware configuration of a speech recognition device 1 according to the embodiment of the present invention. Referring to FIG. 1, the speech recognition device 1 includes a central processing unit (CPU) 11 that performs various computations, a read only memory (ROM) 12 that stores various types of data and programs, a random access memory (RAM) 13 that stores working data and so on, a nonvolatile storage device such as a hard disk 14, an operation unit 15 that includes a keyboard and other types of operating tools, a display unit 16 that displays various types of information, a drive 17 that can read and write data and programs in a recording medium 17a, a communication I/F (interface) 18 that is used to communicate with a network, and an input unit 19 that is used to input speech signals through a microphone 20. The recording medium 17a may be, for example, a compact disc-ROM (CD-ROM) or a memory card.

### (Functional Configuration)

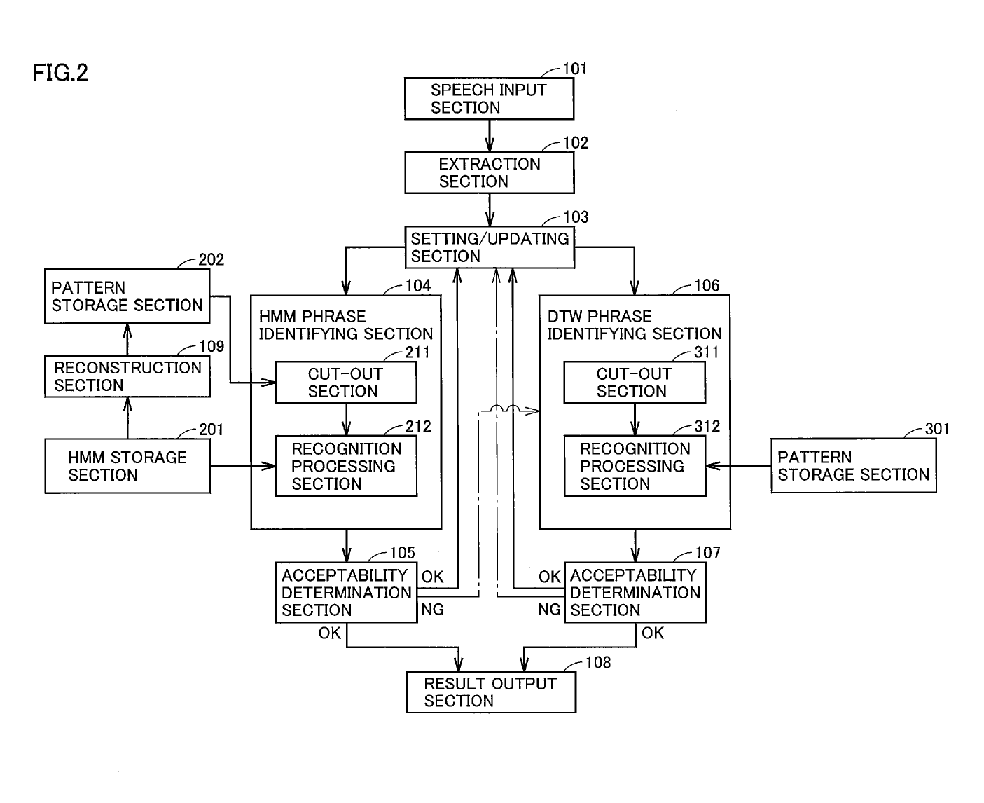

FIG. 2 is a functional block diagram showing the functional configuration of the speech recognition device 1 according to the embodiment of the invention. Referring to FIG. 2, the main functional components of the speech recognition device 1 are a speech input section 101, an extraction section 102, a setting/updating section 103, a HMM phrase identifying section (first identifying section) 104, a DTW phrase identifying section (second identifying section) 106, acceptability determination sections 105, 107, and a result output section 108.

The speech input section 101 inputs speech including a set of continuously uttered HMM phrases and DTW phrases, that is, continuous speech. The extraction section 102 analyzes the input speech to extract the feature values of the speech. Specifically, the extraction section 102 cuts a speech signal into frames of a predetermined time length, and analyzes the speech signal frame by frame to obtain the feature values. For example, the cut-out speech signal is converted into a Mel-frequency cepstral coefficient (MFCC) feature value.

The setting/updating section 103 defines a segment including phrases to be identified by the HMM phrase identifying section 104 and DTW phrase identifying section 106 (hereinafter, the defined segment is referred to as “target segment”) in a whole detected segment of the speech, and updates the range of the target segment.

The HMM phrase identifying section 104 identifies a HMM phrase in a set of the phrases based on model parameters stored in a HMM storage section 201 and the speech feature values extracted by the extraction section 102. The DTW phrase identifying section 106 identifies a DTW phrase in the set of the phrases based on pattern data stored in a pattern storage section 301 and the speech feature values extracted by the extraction section 102.

The acceptability determination section 105 determines whether the HMM phrase identified by the HMM phrase identifying section 104 is acceptable as a recognition result. Similarly, the acceptability determination section 107 determines whether the DTW phrase identified by the DTW phrase identifying section 106 is acceptable as a recognition result.

The result output section 108 confirms the words accepted by the acceptability determination sections 105, 107 as a recognition result and outputs it. Specifically, the result output section 108 outputs the result to the display unit 16.

The HMM phrase identifying section 104 used herein includes not only a recognition processing section 212 that performs phrase recognition in accordance with a well-known HMM method, but also a cut-out section 211. Similarly, the DTW phrase identifying section 106 includes not only a recognition processing section 312 that performs phrase recognition in accordance with a well-known DTW algorithm, but also a cut-out section 311.

The cut-out section 211 of the HMM phrase identifying section 104 cuts out a speech segment having a high probability that a HMM phrase may exist, from the target segment. In other words, the cut-out section 211 performs an extraction process on the target segment to extract a HMM phrase candidate, and cuts out a speech segment including the extracted HMM phrase candidate. More specifically, the HMM phrase candidate is extracted by making comparison between template feature value sequences of a plurality of HMM phrases and the feature value sequence of the speech in the target segment. A description about the template feature value sequences used by the cut-out section 211 will be given later. The recognition processing section 212 thus can identify a HMM phrase based on the feature values of the cut-out speech segment.

Similar to the cut-out section 211 of the HMM phrase identifying section 104, the cut-out section 311 of the DTW phrase identifying section 106 cuts out a speech segment having a high probability that a DTW phrase may exist, from the target segment. In other words, the cut-out section 311 performs an extraction process on the target segment to extract a DTW phrase candidate, and cuts out a speech segment including the extracted DTW phrase candidate. More specifically, the DTW phrase candidate is extracted by making comparison between template feature value sequences of a plurality of DTW phrases and the feature value sequence of the speech in the target segment. The pattern data of the template feature value sequences in this embodiment is used by the recognition processing section 312, and is stored in the pattern storage section 301 when a phrase is additionally stored. Referring to the pattern data, the recognition processing section 312 can identify a DTW phrase based on the feature values in the cut-out speech segment.

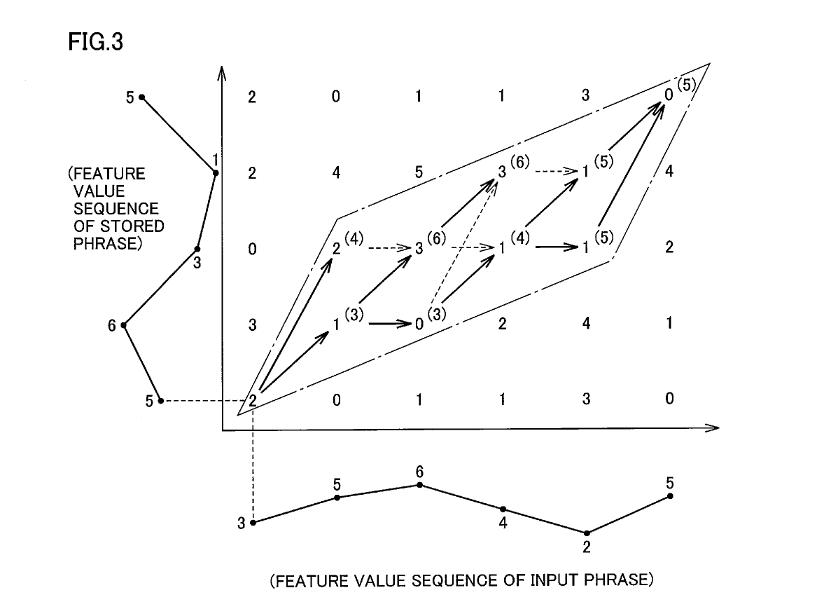

A description about how the cut-out sections 211, 311 extract a phrase (candidate) will be given. To gain a deeper understanding of the phrase extraction process, a brief description about a DTW phrase recognition process in accordance with a DTW algorithm will be firstly given with reference to FIG. 3. In FIG. 3, the horizontal axis indicates a feature value sequence of an input phrase, while the vertical axis indicates a feature value sequence of a DTW phrase (additionally stored word). It is assumed that, for example, the feature value sequence of the input phrase is 3, 5, 6, 4, 2, 5 and the feature value sequence of the DTW phrase is 5, 6, 3, 1, 5.

In the DTW recognition process, the feature value sequence of the input phrase is compared against the template feature value sequence of the DTW phrase to calculate the minimum cumulative distance which indicates similarity between the phrases. The minimum cumulative distance determined in the DTW recognition process is hereinafter referred to as “DTW distance”. In this example, the beginning and the end of the phrases are aligned, the maximum slope is set to “2” and the minimum slope is set to “½”, for example, and the DTW distance is calculated within a parallelogram indicated by a dot-and-dash line. In this case, the DTW distance is “5”. Such a calculation is performed on each of the stored phrases in the DTW phrase recognition process, and a stored phrase having the minimum DTW distance is determined as a recognition result.

On the contrary to the aforementioned DTW recognition process, the cut-out sections 211, 311 compare the template feature value sequences of the stored phrases against the feature value sequence of the input phrase in the extraction process to calculate the minimum cumulative distance which indicates similarity between the phrases. The reason why the source and the target for comparison are switched over between the recognition process and extraction process is that the cut-out sections 211, 311 are not sure which part of the input speech includes a stored phrase, especially in the entire input speech of the continuously uttered phrase set.

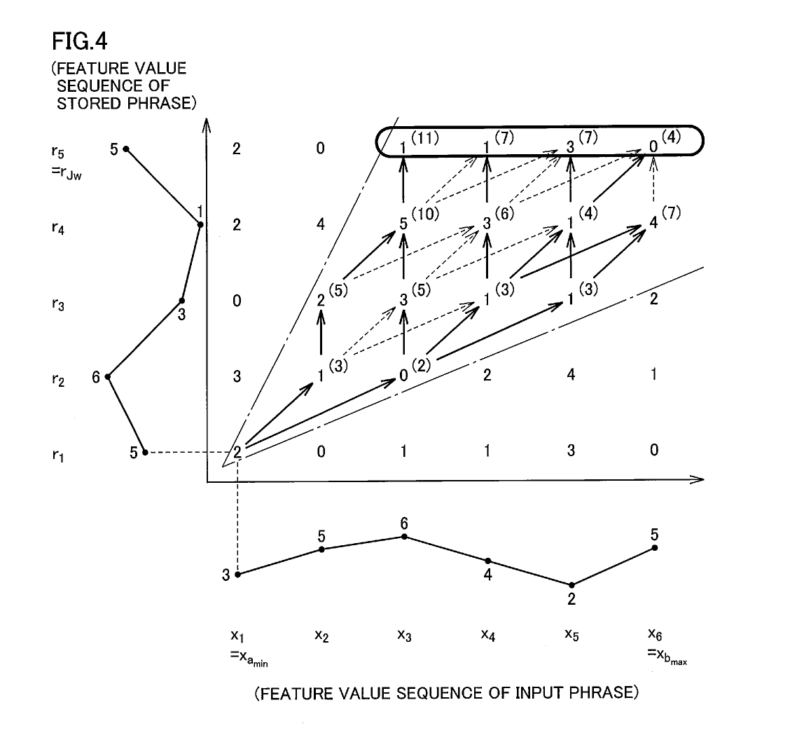

FIG. 4 shows an example computation of the minimum cumulative distance in the phrase extraction process. Similar to FIG. 3, FIG. 4 shows an example computation when, for example, the feature value sequence of an input phrase is 3, 5, 6, 4, 2, 5, and the feature value sequence of a stored phrase is 5, 6, 3, 1, 5. In this example, only the beginning points of the phrases are aligned, the maximum slope is set to “2” and the minimum slope is set to “½”, for example, and the minimum cumulative distance is calculated within a V-shaped area indicated by a dot-and-dash line. Although a plurality of cumulative distances are obtained at the last frame of the stored phrase, the minimum cumulative distance (4) out of the cumulative distances (11, 7, 7, 4) is determined as the minimum cumulative distance of the feature value sequences of both the phrases. Since the numbers of frames of the stored phrases are different from each other, it is preferable to divide the calculated minimum cumulative distance by the number of the frames of the stored phrase to determine the similarity between the phrases.

In order to provide a clear understanding, the feature values are defined along one dimension and the phrases have a very few frames to exemplify the computations in FIGS. 3 and 4; however, the distance calculation for regular input speech can be done by aligning the beginning of a stored phrase with the vicinity of the beginning of an input speech.

By the way, extraction of a DTW phrase is easily feasible with the use of pattern data, which is stored in the pattern storage section 301 for phrase recognition, whereas extraction of a HMM phrase cannot use such pattern data for phrase recognition, and therefore template feature value sequences need to be additionally prepared to enable the aforementioned distance computations.

Therefore, this embodiment enables reconstruction of template feature value sequences of the HMM phrases from the model parameters stored in the HMM storage section 201. Thus, the speech recognition device 1 further includes a reconstruction section 109 to achieve the reconstruction function.

The reconstruction section 109 obtains the feature patterns of respective HMM phrases by calculations from the model parameters stored in the HMM storage section 201 to reconstruct the template feature value sequences. The HMM storage section 201 stores the parameters for every HMM phrase in advance, such as state transition probability, output probability distribution, and initial state probability. The reconstruction section 109 uses at least one of these parameters to reconstruct the template feature value sequences of the respective HMM phrases. A specific reconstruction method will be given below.

It is assumed that a template feature value sequence is generated from a HMM phrase with a state transition probability “aₖₗ” from state k to state l and an output probability distribution “bₖ(y)” of the feature value “y” in state k. The HMM, which will be described herein, is a N-state left-to-right (LR) HMM with no skip, and the output probability distribution of a feature value in state k is a multivariate normal distribution with a mean vector “μₖ” and a covariance matrix “Σₖ”.

The average value of the feature values output in the state k is a mean vector “μₖ”. The average number of the frames when the feature value is output in the state k is “1/(1−aₖₖ)”, and therefore the average value “tₖ” of times at which the state k is changed to state (k+1) is expressed by Expression 1 below.

$$\begin{matrix}[ Expression 1 ] & \\ {t}_{k} = {\sum }_{j = 1}^{k} \frac{1}{1 - {a}_{‖}} & ( 1 )\end{matrix}$$

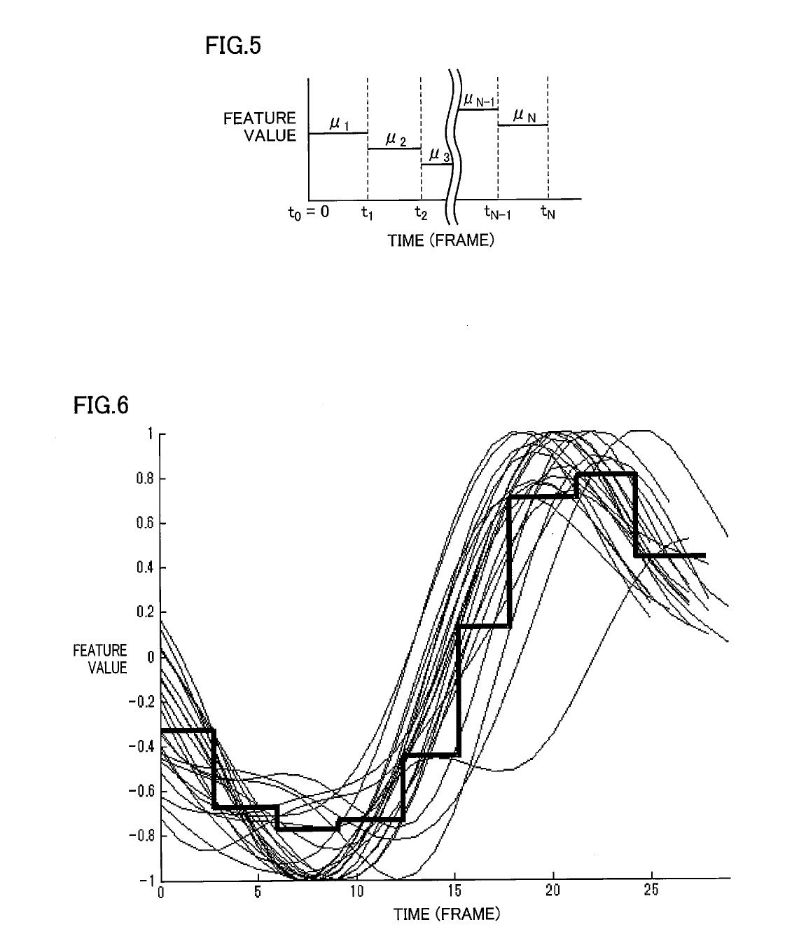

Thus, a template feature value sequence that changes as shown in FIG. 5 is generated in this embodiment. The template feature value sequence can be expressed by Expression 2 below. The average value “t_{N}” of times at which the last feature value is output in state N can be also obtained from the average number of the frames of the feature value sequences of HMM teacher's speech.

$$\begin{matrix}[ Expression 2 ] & \\ \begin{matrix}R = {r}_{1} … {r}_{⌊ {t}_{1} ⌋} {r}_{⌊ {t}_{1} ⌋ + 1} … {r}_{⌊ {t}_{2} ⌋} {r}_{⌊ {t}_{2} ⌋ + 1} … {r}_{⌊ {t}_{N - 1} ⌋} {r}_{⌊ {t}_{N - 1} ⌋ + 1} … {r}_{⌊ {t}_{N} ⌋} \\ = {μ}_{1} … {μ}_{1} {μ}_{2} … {μ}_{2} {μ}_{3} … {μ}_{N - 1} {μ}_{ N} … {μ}_{N}\end{matrix} \\ ( ⌊ t ⌋ \text{:} a maximum integer , but not exceeding t ) & ( 2 )\end{matrix}$$

The graph in FIG. 6 shows the relationship between a plurality of feature value sequences of teacher's speech associated with a HMM phrase and a reconstructed feature value sequence (feature pattern).

The reconstruction section 109 reconstructs the template feature value sequence of each HMM phrase through the calculations as indicated above. The reconstruction section 109 can perform the reconstruction process every time the cut-out section 211 performs a HMM phrase extraction process; however, such a procedure reduces recognition speed. To prevent a reduction in the speed of recognition, it is preferable for the reconstruction section 109 to operate only when a user provides a given instruction, for example, at the time of initialization, and to store pattern data corresponding to the calculated feature pattern into a pattern storage section 202. Alternatively, it is also preferable to store pattern data reconstructed from HMM in the pattern storage section 202 in advance at the time of manufacture or shipping of the speech recognition device 1. In this case, the speech recognition device 1 can dispense with the reconstruction section 109.

The storage sections 201, 202, 301 shown in FIG. 2 are included in, for example, the hard disk 14. The speech input section 101 is implemented by, for example, the input unit 19. The other functional sections are implemented by the CPU 11 that runs software stored in the ROM 12, for example. At least one of these functional sections may be implemented by hardware.

### <Operation>

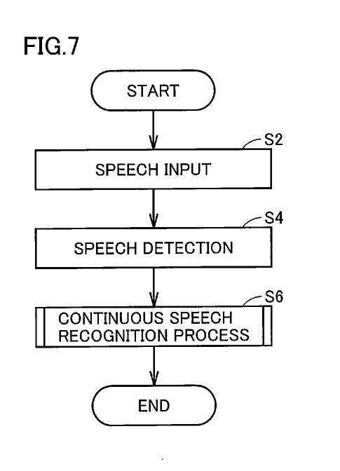

FIG. 7 is a flow chart showing a speech recognition procedure according to the embodiment of the present invention. The procedure shown in the flow chart of FIG. 7 is stored in advance as a program in the ROM 12 and is invoked and executed by the CPU 11 to implement the functions in the speech recognition procedure.

Referring to FIG. 7, speech is input through the speech input section 101 (step S (hereinafter, abbreviated as “S”) 2), and the speech is detected based on the energy of the speech signal and so on (S4). It is assumed that the detected speech includes continuously uttered HMM phrases and DTW phrases.

Subsequent to speech detection, a continuous speech recognition process is performed on the speech within the segment (S6). To deal with undetectable low-energy speech possibly present before and after the detected speech segment, it is preferable to expand the speech segment both forward and backward by about several hundred milliseconds (ms).

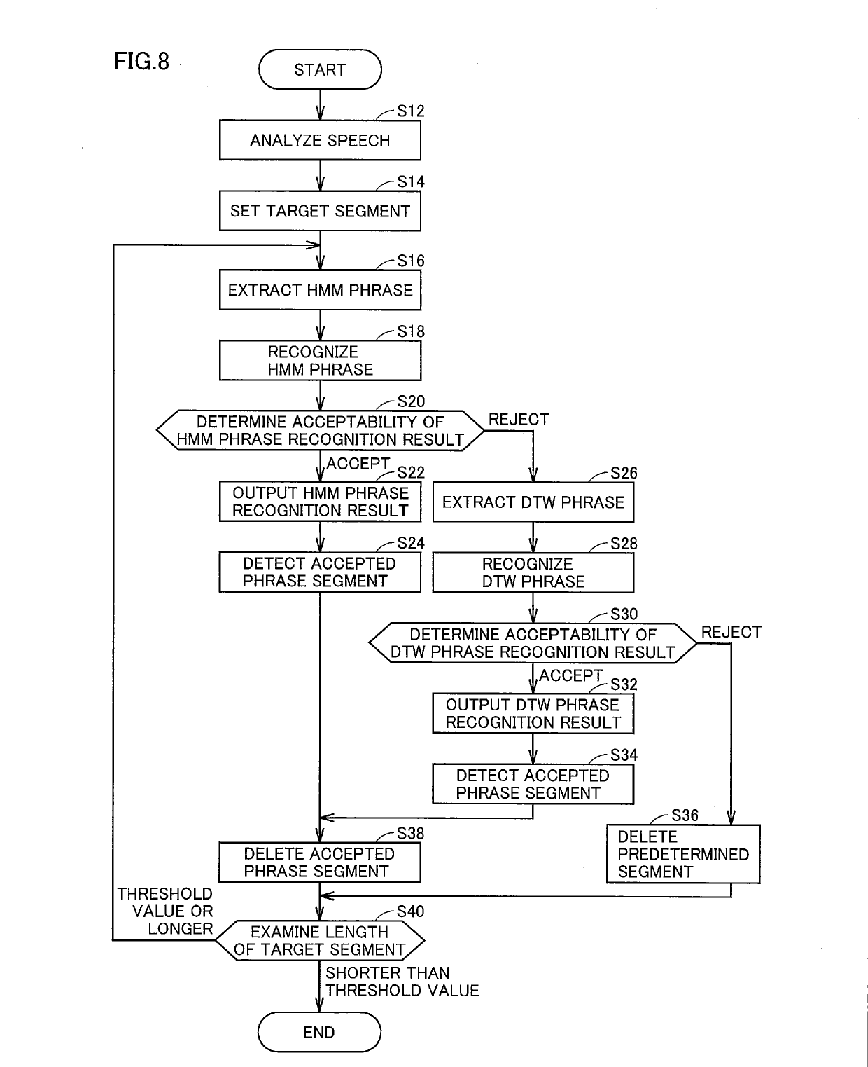

FIG. 8 is a flow chart describing the continuous speech recognition process according to this embodiment. Referring to FIG. 8, the extraction section 102 delimits the detected speech into frames of about 20 ms in length and analyses the frames to extract their feature values, such as MFCC (S12). The extraction section 102 shifts the frames by about 10 ms and repeats analyzing. This step provides a feature value sequence of the detected speech (input speech).

The setting/updating section 103 defines the entire speech segment detected in S4 of FIG. 7 as a target segment (S14).

Once the target segment is set, the cut-out section 211 of the HMM phrase identifying section 104 firstly performs a HMM phrase extraction process (S16). Specifically, the cut-out section 211 compares each of the template feature value sequences of the HMM phrases stored in the pattern storage section 202 against the feature value sequence of the detected speech to extract a HMM phrase candidate. In this description, a phrase extraction process in accordance with the DTW algorithm is performed on the assumption that a HMM phrase is present near the beginning of the target segment.

Specifically, each of the HMM phrases is subjected to the computations as shown in FIG. 4 to obtain the minimum cumulative distance, and the calculated minimum cumulative distance is divided by the number of the frames to determine the minimum cumulative distance per frame. A HMM phrase having the minimum of the minimum per-frame cumulative distances is regarded as a HMM phrase candidate. Such a process can be carried out with predetermined computational expressions. The cut-out section 211 cuts out the speech segment where the extracted HMM phrase candidate is present as a segment that most probably includes a HMM phrase.

The HMM storage section 201 stores not only mean vectors, but also information about variance with respect to the mean vectors, that is, covariance matrices. Therefore, Mahalanobis distance, indicated by Expression 3 below, can be applied to the HMM phrase extraction as a measure of similarity distance in comparison between two feature value sequences.

[Expression 3]

d(rⱼ,y)=\sqrt{(y−μₖ)^{T}Σₖ⁻¹(y−μₖ)} (where rⱼ=μₖ) (3)

The Mahalanobis distance is weighted according to the degree of variance with respect to the mean vector. Therefore, this computation can more accurately extract HMM phrase candidates than similarity computations using Euclidean distance.

Next, the recognition processing section 212 of the HMM phrase identifying section 104 executes a HMM phrase recognition process using the model parameters stored in the HMM storage section 201 (S18). Specifically, the recognition processing section 212 identifies a HMM phrase based on the feature values in the speech segment cut out by the cut-out section 211. In short, the feature value sequence that is obtained as a result of the HMM phrase extraction process is recognized by a HMM method.

As described above, this embodiment does not immediately determine the HMM phrase extracted in S16 as a recognition result, but performs the recognition process through the HMM method suitable for speaker-independent speech recognition, thereby enhancing the recognition accuracy.

The acceptability determination section 105 then determines the acceptability of the recognition result obtained in S18 (S20). Specifically, the acceptability determination section 105 determines whether to accept or reject the HMM phrase identified by the recognition processing section 212 as a recognition result. This acceptability determination can be performed by a simple rejection algorithm. If the first-place HMM phrase has a likelihood value equal to or higher than a threshold value and the likelihood ratio between the first-place HMM phrase and the second-place HMM phrase is equal to or higher than a threshold value, the first-place HMM phrase is accepted, otherwise it is rejected. These threshold values are obtained in advance from prestored words, and are stored.

If the identified HMM phrase is accepted as a recognition result (“accept” in S20), the result output section 108 outputs the accepted HMM phrase as a recognition result (S22).

If the extracted HMM phrase candidate is different from the accepted HMM phrase, the segment where the accepted HMM is present is detected again in the analogous manner where the cut-out section 211 cuts out the speech segment (S24). The procedure proceeds to Step S38 after completion of this process.

If the identified HMM phrase is rejected in S20 (“reject” in S20), it is determined that there is no HMM phrase around the beginning of the target segment, and the procedure goes to S26 where it is determined whether a DTW phrase is present around the beginning of the target segment.

In the case where the recognition result that is obtained from the speech segment of the first-place HMM phrase candidate having the highest similarity in the HMM phrase extraction process (S16) is rejected, a HMM phrase recognition process can be performed again without immediately proceeding to S26. Specifically, a HMM phrase recognition process (S18) and an acceptability determination process (S20) can be performed on the speech segment of the second-place HMM phrase candidate, which has the second highest similarity in the HMM phrase extraction process. In this case, the HMM phrase to be output in S22 may be a phrase that is recognized in the re-recognition process and accepted. This can improve the recognition accuracy of the input speech. Such a re-recognition process can be performed on the speech segments of (a predetermined number of) HMM phrases in the second place or lower.

In S26, the cut-out section 311 of the DTW phrase identifying section 106 executes a DTW phrase extraction process. Specifically, the cut-out section 311 compares template feature value sequences of DTW phrases associated with pattern data stored in the pattern storage section 301 against the feature value sequence of the detected speech to extract a DTW phrase candidate. In this example, the phrase extraction process is performed in accordance with the DTW algorithm on the assumption that a DTW phrase is present near the beginning of the target segment.

Specifically, each of the DTW phrases is subjected to the computations as shown in FIG. 4 to obtain the minimum cumulative distance, and the calculated minimum cumulative distance is divided by the number of the frames to determine the minimum cumulative distance per frame. A DTW phrase having the minimum of the minimum per-frame cumulative distances is regarded as a DTW phrase candidate. Such a process also can be carried out with predetermined computational expressions. The cut-out section 311 cuts out the speech segment where the extracted DTW phrase candidate is present as a segment that most probably includes a DTW phrase.

Next, the recognition processing section 312 of the DTW phrase identifying section 106 executes a DTW phrase recognition process using the same pattern data stored in the pattern storage section 301 (S28). Specifically, the recognition processing section 312 compares the feature value sequence within the speech segment cut out by the cut-out section 311 against the template feature value sequences of the respective DTW phrases to identify a DTW phrase. In short, the feature value sequence that is obtained as a result of the DTW phrase extraction process is recognized by the DTW algorithm.

There is a reason why the result obtained by the DTW phrase extraction in S26 is not immediately determined as a recognition result and is additionally subjected to a recognition process in accordance with the DTW algorithm. In general, in the phrase extraction algorithm, the number of times in which each of the feature values of an input speech is compared varies depending on the template feature value sequences as a source, and the comparison may not be always performed one time for all the feature values of the input speech. These factors suggest that the recognition accuracy of the phrase extraction algorithm becomes slightly low.

Subsequently, the acceptability determination section 107 determines the acceptability of the recognition result obtained in S28 (S30). Specifically, the acceptability determination section 107 determines whether to accept or reject the DTW phrase identified by the recognition processing section 312 as a recognition result. This acceptability determination can be performed by a simple rejection algorithm. If the first-place DTW phrase has a DTW distance equal to or lower than a threshold value, the first-place DTW phrase is accepted, otherwise it is rejected. The threshold value can be obtained from additionally stored words.

Alternatively, the acceptability determination section 107 may accept the first-place DTW phrase if the difference of DTW distance between the first-place DTW phrase and the second-place DTW phrase is equal to or higher than a predetermined value, while rejecting it if the difference is lower than the predetermined value.

If the identified DTW phrase is accepted as a recognition result (“accept” in S30), the result output section 108 outputs the accepted DTW phrase as a recognition result (S32).

Also after this acceptance, if the extracted DTW phrase candidate is different from the accepted DTW phrase, the segment where the accepted DTW phrase is present is detected again in the analogous manner where the cut-out section 311 cuts out the speech segment (S34). The procedure proceeds to Step S38 after completion of this process.

In S38, the setting/updating section 103 deletes the segment of the accepted phrase from the target segment and updates the target segment. Specifically, the setting/updating section 103 deletes the feature value sequence from the beginning of the target segment to the end of the segment from which the accepted phrase was extracted. In other words, the beginning of the target segment is shifted backward only by the deleted segment.

On the other hand, if the DTW phrase is rejected in S30 (“reject” in S30), the setting/updating section 103 deletes a predetermined segment from the target segment (S36). Specifically, the feature value sequence corresponding to about 100 ms to 200 ms is deleted from the beginning of the target segment. In other words, the beginning of the target segment is shifted by about 100 ms to 200 ms backward.

Even if the recognition result that is obtained from the speech segment of the first-place DTW phrase candidate in the DTW phrase extraction process (S26) is rejected, a DTW phrase recognition process can be performed again without immediately proceeding to S36. Specifically, a DTW phrase recognition process (S28) and an acceptability determination process (S30) can be performed on the speech segment of the second-place DTW phrase candidate obtained in the DTW phrase extraction process. In addition, the DTW phrase re-recognition process can be performed on the speech segment of (a predetermined number of) DTW phrase candidates in the second place or lower.

After the target segment is updated, the length of the target segment is examined (S40). If the time length of the target segment is equal to or longer than a threshold value (“threshold value or longer” in S40), it is determined that the target segment may possibly include a phrase, and the procedure returns to S16 to repeat the aforementioned processes. Otherwise (“shorter than threshold value” in S40), the series of the processes are terminated. The threshold value can be obtained from the time length of the HMM phrases and DTW phrases. For example, a half of the time length of the shortest phrase in the HMM phrases and DTW phrases may be set as the threshold value.

According to the aforementioned speech recognition method of the present embodiment, phrase extraction in accordance with the DTW algorithm can be made using template feature value sequences of the HMM phrases, and therefore continuous speech recognition can be achieved without syntax analyses. However, for further improvement of recognition accuracy, syntax analyses can be combined with the speech recognition method of this embodiment.

The reconstruction of the template feature value sequences of the HMM phrases from the HMM parameters eliminates the necessity of training sessions involving a teacher's speech. This simplifies the continuous speech recognition processes.

In addition, reconstructing time-series data of covariance matrices in conjunction with the reconstruction of the template feature value sequences from the HMM parameters makes it possible to assign weight to distances according to the variance of the feature values in the HMM phrase candidate extraction process. Thus, the accuracy with which to extract candidates can be improved.

The final recognition process for a HMM phrase is carried out in accordance with the HMM method, and the final recognition process for a DTW phrase is carried out in accordance with the DTW algorithm using a feature value sequence of an input speech, which is compared as a source, and template feature value sequences, which are compared as a target, thereby preventing degradation of the recognition rate.

Unlike commonly used DTW algorithms, the extraction processes of HMM phrases and DTW phrases use the template feature value sequences as a source, thereby searching an optimal range of input speech to recognize phrases. In addition, distance calculations usually required several thousand times per phrase can be reduced to one time. This will be described in further detail.

In general DTW phrase extraction, subsequences are taken out from a feature value sequence of input speech and are compared as a source against template feature value sequences to calculate the minimum cumulative distances. In this case, a phrase that is most probably present in the subsequence and its minimum cumulative distance are determined for each of the subsequences taken out. Such calculations are performed on every subsequence. Then, the minimum cumulative distance of each subsequence is divided by the number of frames, corresponding to the length of the subsequence, to find a subsequence with the minimum of the minimum cumulative distances. In this manner, a phrase that is most probably present in the found subsequence is extracted. The calculations need to be performed approximately several thousand times for every phrase, because there are approximately several thousand ways to take out subsequences from input speech. Even general HMM phrase extraction requires approximately several thousand calculations to obtain a log likelihood for one phrase.

On the other hand, the minimum cumulative distance of respective phrases (w) is calculated in this embodiment by comparing template feature value sequences as a source against a feature value sequence of input speech as a target, and then is divided by the length of the template feature value sequence. Among the phrases (w), a phrase W* with the minimum of the minimum per-length cumulative distances is obtained. The phrase W* is obtained by Expression 4 below that can reduce the number of calculations for the distances of the respective phrases (w) to only one.

$$\begin{matrix}[ Expression 4 ] & \\ {W}^{*} = {arg min}_{W} \frac{1}{Jw} D ( Rw , X ( {a}_{min} , {b}_{max} ) ) & ( 4 )\end{matrix}$$

In Expression 4, “Rw” denotes the template feature value sequence of a phrase w, “Jw” denotes the length of the template feature value sequence, “aₘᵢₙ” denotes the minimum value of the beginning frame number “a”, “bₘₐₓ” denotes the maximum value of the end frame number “b”. In addition, “X (aₘᵢₙ, bₘₐₓ)” denotes a subsequence ranging from aₘᵢₙ frame to borax frame taken out from a feature value sequence X of input speech. In this case, the minimum cumulative distance “D (Rw, X(aₘᵢₙ, bₘₐₓ))” where Rw is a source and X(aₘᵢₙ, bₘₐₓ) is a target is defined by Expression 5 below. For reference purposes, FIG. 4 shown earlier depicts the relationship between the feature value sequences of an input phrase and a stored phrase and the symbols of Expression 5.

$$\begin{matrix}[ Expression 5 ] & \\ D ( Rw , X ( {a}_{min} , {b}_{max} ) ) = {min}_{{q}_{1} … {q}_{Jw}} {\sum }_{i = 1}^{Jw} d ( {r}_{wi} , {x}_{{a}_{min} - 1 + qi} ) & ( 5 )\end{matrix}$$

Expression 5 includes “q₁ . . . q_{Jw}” that are subjected to the following constraints.

$$\begin{matrix}[ Expression 6 ] & \\ {a}_{min} ≦ {a}_{min} - 1 + {q}_{1} ≦ {a}_{max} & condition ( 1 ) \\ {b}_{min} ≦ {a}_{min} - 1 + {q}_{Jw} ≦ {b}_{max} & condition ( 2 ) \\ \frac{1}{2} ( i - 1 ) ≦ {q}_{i} - 1 & condition ( 3 ) \\ {q}_{i} - ( {a}_{max} - {a}_{min} + 1 ) ≦ 2 ( i - 1 ) & condition ( 4 ) \\ 2 ( Jw - i ) ≦ {b}_{min} - {a}_{min} + 1 - {q}_{i} & condition ( 5 ) \\ {b}_{max} - {a}_{min} + 1 - {q}_{i} ≦ \frac{1}{2} ( Jw - i ) & condition ( 6 ) \\ {q}_{i} ≧ {q}_{i - 1} & condition ( 7 ) \\ {q}_{i} ≦ {q}_{i - 1} + 2 & condition ( 8 )\end{matrix}$$

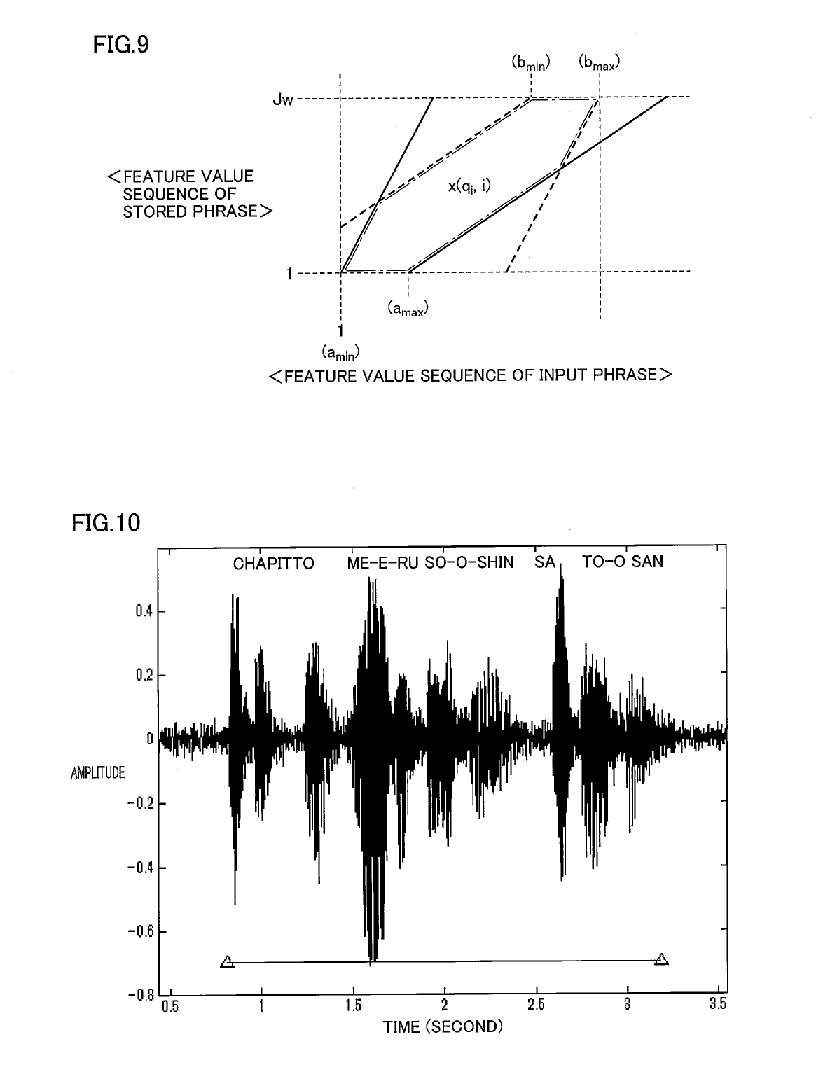

FIG. 9 shows an area surrounded by a dot-and-dash line, the area being defined by inequalities listed in conditions (1) to (6). In this embodiment, the minimum cumulative distance is calculated for each phrase within the area.

Expression 4 performed by the cut-out sections 211, 311 can significantly shorten the time required for the phrase extraction process. Expression 4 is ideal for the phrase extraction; however, the comparison target can be changed from a feature value sequence of input speech to any subsequences taken out from the feature value sequence of the input speech, while the comparison source remains the same as that in the phrase extraction process of this embodiment.

### <Experiment Results>

An experiment was conducted on continuous speech “Chapitto (Chapit), me-e-ru so-o-shin (send mail), Sato-o san (Mr. (or Mrs., Ms) Satoh)” in accordance with the continuous speech recognition method of the present embodiment, and the experiment results will be described below.

FIG. 10 shows the waveform of the input continuous speech. “Chapitto” and “Sato-o san” are DTW phrases additionally stored by a user, while “me-e-ru so-o-shin” is a HMM phrase stored in advance. “Chapitto” is a name of a robot equipped with the speech recognition device 1 according to the embodiment. This robot is designed to be able to remotely control a device, such as a cellular phone.

The input speech was subjected to speech detection based on the energy of its own speech signals, and the speech composed of a set of the phrases was detected from a time of 0.81 seconds to a time of 3.18 seconds on the graph of FIG. 10 (between triangles Δ) (S4 in FIG. 7).

The waveform of the input speech in FIG. 10 shows that the time intervals between the phrases are shorter than a doubled consonant (known as “sokuon” in Japanese) “tt” of “Chapitto”. If the speech is subjected to phrase-by-phrase detection based on the energy of the speech signal, “Chapitto” is delimited at “tt”. The recognition method according to this embodiment has been designed in order to recognize such speech that is difficult to be detected and recognized phrase by phrase.

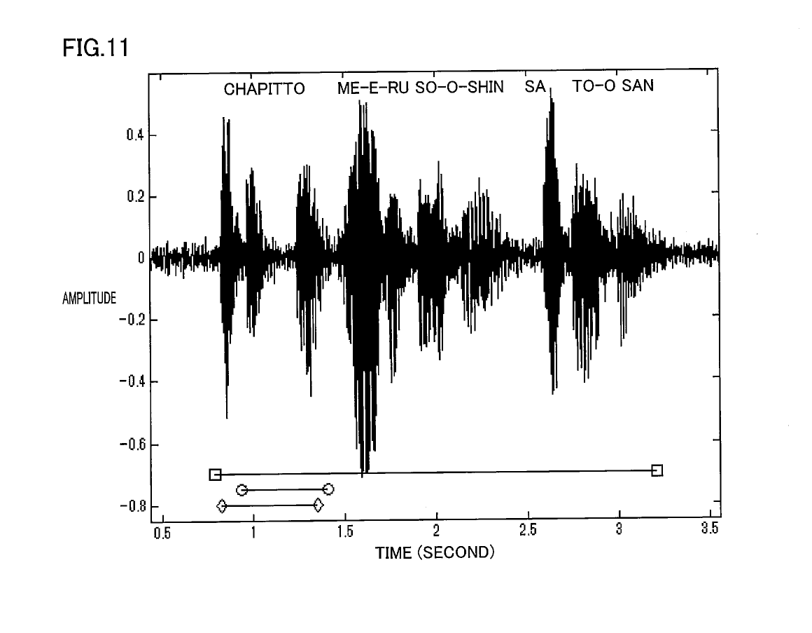

The beginning and the end of a target segment, which was defined in step S14 of FIG. 8, are indicated by squares □ in FIG. 11. The target segment at this stage is almost equal to the segment of the detected speech (between triangles Δ in FIG. 10).

The speech recognition device 1 estimated the probability that a HMM phrase was present near the beginning of the target segment, and tried to obtain a most probable word and a segment including the word. Consequently, a phrase “migi ni ido-o (move rightward)” was extracted as word candidates (S16 in FIG. 8). It was also determined that the phrase was most probably present from a time of 0.91 seconds to a time of 1.43 seconds (between circles ∘).

Then, the speech segment from the time of 0.91 seconds to the time of 1.43 seconds was cut out to undergo HMM recognition. The result was “Gamen kirikae (switch screen)” (S18 in FIG. 8). This recognition result underwent an acceptability determination process, but was rejected (“reject” in S20 in FIG. 8).

Because the recognition result was rejected, the speech recognition device 1 then estimated the probability that a DTW phrase was present near the beginning of the target segment and tried to obtain a most probable word and a segment including the word. Consequently, a phrase “Chapitto” was extracted as a word candidate (S26 in FIG. 8). It was determined that the phrase was most probably present from a time of 0.80 seconds to a time of 1.37 seconds (between rhombuses ♦).

Then, the speech segment from the time of 0.80 seconds to the time of 1.37 seconds was cut out to undergo DTW recognition. The result was “Chapitto” (S28 in FIG. 8). This recognition result underwent an acceptability determination process, and was accepted (“accept” in S30 in FIG. 8). Through these steps, “Chappito” was output as the first recognition result (S32 in FIG. 8).

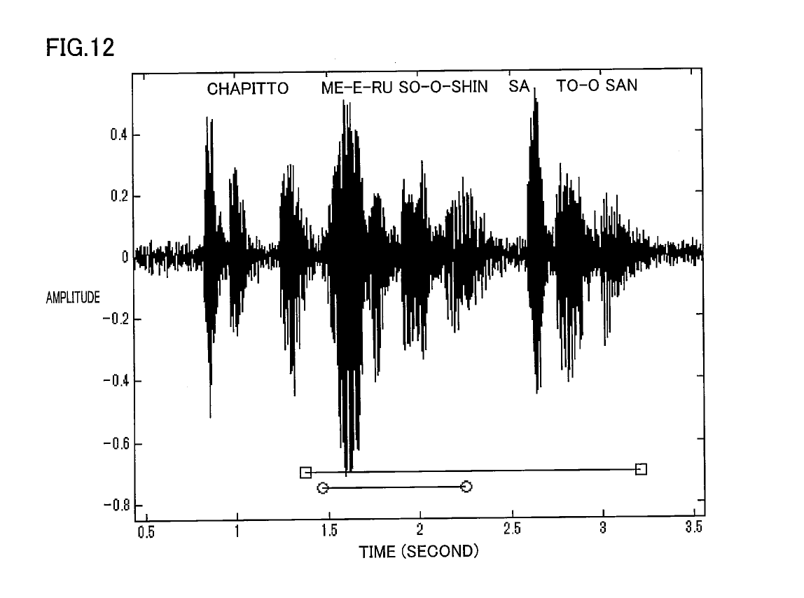

After the word was accepted, the target segment to be recognized was updated to a new target segment (between squares □) shown in FIG. 12 (S38 in FIG. 8). Specifically, the new target segment started at a time of 1.38 seconds, which was immediately after the end of “Chapitto”, and ended at a time of 3.18 seconds, which was the end of the detected speech segment. The speech in the updated target segment was subjected to the second identifying process (“threshold value or longer” in S40 in FIG. 8).

The speech recognition device 1 estimated the probability that a HMM phrase was present near the beginning of the target segment and tried to obtain the most probable word and a segment including the word. Consequently, it was determined that a phrase “me-e-ru so-o-shin” was most probably present from a time of 1.44 seconds to a time of 2.28 seconds (between circles ∘) (S16 in FIG. 8).

Then, the speech in the speech segment from the time of 1.44 seconds to the time of 2.28 seconds was subjected to a recognition process. The result was “me-e-ru so-o-shin” (S18 in FIG. 8). This recognition result underwent an acceptability determination process, and was accepted (“accept” in S20 in FIG. 8), and therefore “me-e-ru so-o-shin” was output as the second recognition result (S22 in FIG. 8).

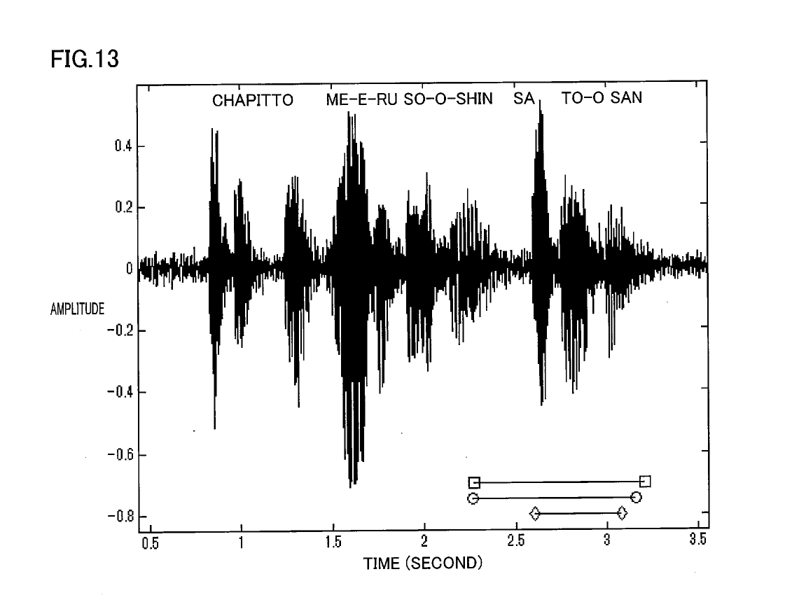

After the word was accepted, the target segment to be recognized was updated to a new target segment (between squares □) shown in FIG. 13 (S38 in FIG. 8). Specifically, the new target segment started at a time of 2.29 seconds, which was immediately after the end of “me-e-ru so-o-shin”, and ended at a time of 3.18 seconds, which was the end of the detected speech segment. The speech in the updated target segment was subjected to the third identifying process (“threshold value or longer” in S40 in FIG. 8).

The speech recognition device 1 estimated the probability that a HMM phrase was present near the beginning of the target segment and tried to obtain the most probable word and a segment including the word. Consequently, it was determined that a phrase “messe-e-ji mo-o-do (message mode)” was most probably present from a time of 2.24 seconds to a time of 3.18 seconds (between circles ∘) (S16 in FIG. 8). Then, the speech in the speech segment from the time of 2.24 seconds to the time of 3.18 seconds was subjected to a recognition process. The result was “nyu-u-ryoku kirikae (input switching)” (S18 in FIG. 8). This recognition result underwent an acceptability determination process, but was rejected (“reject” in S20 in FIG. 8).

Subsequently, the speech recognition device 1 estimated the probability that a DTW phrase was present near the beginning of the target segment and tried to obtain the most probable word and a segment including the word. Consequently, it is determined that a phrase “Sato-o san” was most probably present from a time of 2.58 seconds to a time of 3.10 seconds (between rhombuses ♦) (S26 in FIG. 8). Then, the speech from the time of 2.58 seconds to the time of 3.10 seconds was subjected to a recognition process, and the result was “Sato-o san” (S28 in FIG. 8). This recognition result underwent an acceptability determination process, and was accepted (“accept” in S30 in FIG. 8), and “Sato-o san” was output as the third recognition result (S32 in FIG. 8).

The target segment was updated, and the updated segment ranges from a time of 3.11 seconds, which was immediately after the end of “Sato-o san”, to a time of 3.18 seconds, which was the end of the detected speech segment (S38 in FIG. 8). However, since the updated target segment had a very short length of 0.07 seconds, the speech recognition device 1 determined that no phrase was present in the target segment (“shorter than threshold value” in S40 in FIG. 8), and terminated the recognition process.

The above-described experiment shows that the continuous speech was accurately recognized. This proves that the speech recognition device 1 according to the embodiment can enhance users' satisfaction.

Although the template feature value sequence reconstructed from the HMM parameters takes the form of a staircase in this embodiment as shown in the graph in FIG. 6, it is possible to reconstruct the template feature value sequence into a curved line by using an interpolation process, such as polynomial interpolation and spline interpolation.

Although the phrase extraction process is performed on the assumption that a stored phrase is present near the beginning of the target segment in this embodiment, it is also possible to perform the phrase extraction process on the assumption that a stored phrase is present near the end of the target segment. In this case, the target segment can be updated by deleting the feature value sequence from the beginning of the segment from which the accepted phrase is extracted to the end of the target segment. Deletion of a predetermined segment at the rejection can be done by deleting a feature value sequence corresponding to about 100 ms to 200 ms from the end of the target segment.

In this embodiment, the HMM phrase identifying process and the DTW phrase identifying process are performed on speech in a target segment in series; however, those processes can be also performed in parallel. In this case, the acceptability determination section makes the above-described determination for both the likelihood of a HMM phrase and the DTW distance of a DTW phrase, and accepts one of them or rejects both.

In this embodiment, not only the HMM phrase identifying section 104, but also the DTW phrase identifying section 106 has a cut-out section and a recognition processing section. However, identification of a DTW phrase requires feature value sequences of DTW phrases to be used in both the extraction process and recognition process, and therefore extraction of a DTW phrase candidate in the extraction process is relatively highly accurate. For the high accuracy, the DTW phrase identifying section 106 is allowed to determine the DTW phrase candidate extracted in the extraction process as an identified result (recognition result). In other words, the DTW phrase identifying section 106 simply compares the feature value sequences of the DTW phrases against the feature value sequence of speech in a target segment to identify an additionally stored word included in the uttered speech (phrase set).

The method for recognizing speech executed by the speech recognition device 1 according to the embodiment can be provided in the form of a program. Such a program can be provided by storing it in an optical medium, such as a compact disc-ROM (CD-ROM), and a non-transitory recording medium, such as a memory card, readable by a computer. Alternatively, the program can be provided by making it available for download via a network.

It should be noted that the program according to the present invention may invoke necessary modules, among program modules provided as part of a computer operating system (OS), in a predetermined sequence at predetermined timings to cause the modules to perform processing. In this case, the program itself does not include such modules, but executes the processing in cooperation with the OS. Such a program that does not include the modules can be also admitted as a program according to the present invention.

Also, the program according to the present invention may be provided by being incorporated in part of another program. In this case as well, the program itself does not include such modules, but the other program includes the modules, and the program executes the processing in cooperation with the other program. Such a program incorporated in the other program can be also admitted as a program according to the present invention.

It should be understood that the embodiment disclosed herein is illustrative and non-restrictive in every respect. The scope of the present invention is defined by the terms of the claims, rather than by the foregoing description, and is intended to include any modifications within the scope and meaning equivalent to the terms of the claims.

What is claimed is:

1. A speech recognition device comprising:
a storage section that stores model parameters of a plurality of prestored words and pattern data of feature value sequences of a plurality of additionally stored words added by a user;
a speech input section that inputs speech of a phrase set including a prestored word and an additionally stored word continuously uttered;
a first identifying section that identifies the prestored word included in the phrase set based on the model parameters stored in the storage section and feature values of the speech input by the speech input section; and
a second identifying section that identifies the additionally stored word included in the phrase set based on the pattern data stored in the storage section and the feature values of the speech input by the speech input section, wherein
the first identifying section includes
a cut-out section that extracts a prestored word candidate by making comparison between template feature value sequences of the prestored words and a feature value sequence of the speech in a target segment, and cuts out a speech segment where the extracted p restored word candidate is present, and
a recognition processing section that identifies the prestored word based on feature values in the speech segment cut out by the cut-out section through a recognition process using the model parameters.

2. The speech recognition device according to claim 1, further comprising:
an acceptability determination section that determines whether the word, that is identified by the first identifying section or the second identifying section, is acceptable as a recognition result;
an output section that outputs the word accepted by the acceptability determination section; and
an updating section that updates the target segment by deleting the speech segment where the word accepted by the acceptability determination section is present from the target segment.

3. The speech recognition device according to claim 2, wherein
the first identifying section firstly performs an identifying process on the speech in the target segment to identify the prestored word, and if the identified result provided by the first identifying section is rejected by the acceptability determination section, the second identifying section performs the identifying process on the speech in the target segment to identify the additionally stored word.

4. The speech recognition device according to claim 1, wherein
the template feature value sequences used by the cut-out section are reconstructed from the model parameters.

5. The speech recognition device according to claim 4, further comprising
a reconstruction section that reconstructs the template feature value sequences by determining by calculations feature patterns of the respective prestored words from the model parameters stored in the storage section.

6. The speech recognition device according to claim 1, wherein
the cut-out section performs weighting based on variance information included in the model parameters to extract the p restored word candidate.

7. The speech recognition device according to claim 1, wherein
the second identifying section includes
a cut-out section that extracts an additionally stored word candidate by comparing feature value sequences corresponding to the pattern data against the feature value sequence of the speech in the target segment and cuts out a speech segment where the extracted additionally stored word candidate is present, and
a recognition processing section that performs a recognition process for the additionally stored word by comparing a feature value sequence in the cut-out speech segment where the additionally stored word candidate is present against the feature value sequences corresponding to the pattern data.

8. The speech recognition device according to claim 1, wherein
the second identifying section identifies the additionally stored word by comparing the feature value sequences corresponding to the pattern data against the feature value sequence of the speech in the target segment.

9. A method for recognizing speech comprising the steps of;
inputting speech of a phrase set including a prestored word and an additionally stored word continuously uttered;
firstly identifying the prestored word included in the phrase set based on model parameters of a plurality of prestored words and feature values of the input speech; and
secondly identifying the additionally stored word included in the phrase set based on pattern data of feature value sequences of a plurality of additionally stored words added by a user and the feature values of the input speech, wherein
the first identifying step includes the steps of
extracting a prestored word candidate by making comparison between template feature value sequences of the prestored words and a feature value sequence of the speech in a target segment, and cutting out a speech segment where the extracted prestored word candidate is present, and
identifying the p restored word based on feature values in the cut-out speech segment through a recognition process using the model parameters.
